(19) United States
(12) Patent Application Publication
(10) Pub. No.: US 2004/0063069 A1
(43) Pub. Date: Apr. 1, 2004

(54) External locking dental implant system

(76) Inventor: Steven B. Lombardi, New Castle, PA (US)

Correspondence Address: Steven B. Lombardi, 2415 Wilmington Road, New Castle, PA, 16105, US

(21) Appl. No.: 10/259,546

(22) Filed: Sep. 30, 2002

(51) Int. Cl. A61C 8/00

(52) U.S. Cl. 433/173

(57) ABSTRACT

A dental implant system having an implant and a coordinating abutment is described. The implant includes a hexagonal reference post against which a prosthesis can be keyed and a tapered wall on the external aspect of the neck of the implant. The abutment is adapted to engage the taper of external aspect of the implant and can be indexed via the hex relative to the implant. In an alternative embodiment, different abutments are provided to offer different prosthetic options all using the external friction lock and the external hex for indexing.

### REFERENCES CITED

### U.S. PATENT DOCUMENTS

| | | | |
|---|---|---|---|
| 2112007 | March 1938 | Adams | 433/174. |
| 4416629 | November 1983 | Mozsary et al. | 433/173. |
| 4624673 | November 1986 | Meyer | 623/16. |
| 4960381 | October 1990 | Niznick | 433/174. |
| 5246370 | September 1993 | Coatoam | 433/173. |
| 5282746 | February 1994 | Sellers et al. | 433/172. |
| 5417568 | May 1995 | Giglio | 433/173. |
| 5417569 | May 1995 | Perisse | 433/173. |
| 5584693 | December 1996 | Nishihara | 433/169. |
| 5636989 | June 1997 | Somborac et al. | 433/173. |

### OTHER REFERENCES

Bengazi, et al., 1996, “Recession of the soft tissue margin at oral implants”, Clinical Oral Implants Research, 7:303-310.

Branemark, et al., 1985, “Tissue-Integrated Prostheses”, Quintessence Publishing Co., Inc., p.11-76.

John B. Brunski, 1988, “Biomechanics of Oral Implants: Future Research Directions”, Journal of Dental Education, 52:775-787.

Buser, et al., 1991, “Tissue Integration of One-Stage ITI Implants: 3-Year Results of a Longitudinal Study With Hollow-Cylinder and Hollow-Screw Implants”, The International Journal of Oral & Maxillofacial Implants, 6:405-412.

Chiche, et al., 1998, “Multidispilinary Implant Dentistry for Improved Aesthetics and Function”, Pract Periodont. Aesthet. Dent., 10:177-186.

Gomez-Roman, et al., 1997, “The Frialit-2 Implant System: Five-Year Clinical Experience in Single-Tooth and Immediately Postextraction Applications”, The International Journal of Oral & Maxillofacial Implants, 12:299-309.

“Kirsch, et al., 1989., “The IMZ Osteointegrated Implant System”, Dental Clinics of North America, 33:733-791.

Langer, et al., 1993, “The Wide Fixture: A Solution for Special Bone Situations and a Rescue for the Compromised Implant. Part 1”, The International Journal of Oral & Maxillofacial Implants, 8:400-408.

Roland M. Meffert, DDS, 1988, “The Soft Tissue Interface in Dental Implantology”, Journal of Dental Education, 52:810-811.

Olsson, et al., 1995, “MkII-A Modified Self-Tapping Branemark Implant: 3-Year Results of a Controlled Prospective Pilot Study”, The International Journal of Oral & Maxillofacial Implant, 10: 15-21.

Prestipino, et al., January/February 1993, “Esthetic High-Strength Implant Abutments. Part 1”, Journal of Esthetic Dentistry, p. 29-35.

Saadoun, et al., 1998, “Periodontal Implications in Implant Treatment Planning for Aesthetic Results”, Pract. Periodont. Aesthet. Dent., 10:655-664.

Schnitman, et al., 1988, “Implants for Partial Edentulism”, Journal of Dental Education, 52:725-736.

Siegele, et al., 1989, “Numerical Investigations of the Influence of Implant Shape on Stress Distribution in the Jaw Bone”, The International Journal of Oral & Maxillofacial Implants, 4:333-340.

Sullivan, et al., May/Jun. 1993, “Considerations for Successful Single Tooth Implant Restorations”, Journal of Esthetic Dentistry, 5:119-124.

Wennerberg, et al., 1993, “Design and Surface Characteristics of 13 Commercially Available Oral Implant Systems”, International Journal of Oral & Maxillofacial Implants, 8:622-633.

### BACKGROUND

The present invention relates to a dental implant system that includes an implant and an abutment. The implant has external tapered walls and the abutment has a flange to reduce the risk of abutment loosening. The implant has an external hex that corresponds to an internal hex on the abutment to be used to index the components. The hex component is one subset of any irregular wrench-engaging element.

Dental implants are embedded in the jawbone and serve to anchor one or more artificial teeth, or prosthesis. Initially, the implant is secured within the jawbone, and then the artificial tooth is anchored to the implant. Typically, the artificial tooth is inserted in a multi-step process that includes initially attaching an abutment to the implant, and then securing by means of dental cement or screw retention a finished prosthesis to the abutment. Because the artificial tooth must be in specific alignment within the mouth to be consistent with the other teeth, it is beneficial to have a reference on the implant against which the artificial tooth can be indexed or aligned. Ideally, once the artificial tooth is keyed to the reference of the implant, the tooth will be fixed in position and will not dislodge or rotate within the mouth during mastication. It is beneficial for the practitioner to be able to disassemble the components when necessary, however, the components must be fixed with no micro-movement. Micro-movement between the components over time will cause failure of the connection and require remaking the prosthesis. Thus, it would be beneficial to have a dental implant that could index prosthesis, permit retrievabililty, but eliminate micro-movement between the components over time, withstanding the forces of mastication.

### BRIEF SUMMARY OF THE INVENTION

The present invention relates to a dental implant system having an implant with an external hexagonal reference post against which an abutment can be indexed and a tapered external wall against which the flange of the abutment will friction fit, which will minimize the possibility of micro-movement between the components which may cause premature failure of the assembly. The invention includes any irregular wrench-engaging element as an indexing component. The invention consists of the external taper on the outer wall of the implant that fits to the abutment flange to eliminate micro-movement between the components.

### DESCRIPTION OF DRAWINGS

FIG. 1 is a perspective view of a dental implant system made in accordance with the present invention anchored in the lower jawbone

FIG. 2 is a side cross sectional view of the dental implant in FIG. 1

FIG. 2A is a side view of the dental implant in FIG. 1

FIG. 3 is a top view of the dental implant in FIG. 1

FIG. 4 is a side cross sectional view of the abutment in FIG. 1

FIG. 4A is a side view of the abutment of FIG. 4

### DETAILED DESCRIPTION OF DRAWINGS

The dental implants depicted in the various figures are selected solely for the purposes of illustrating the invention. Other and different dental implants may utilize the inventive features described herein as well.

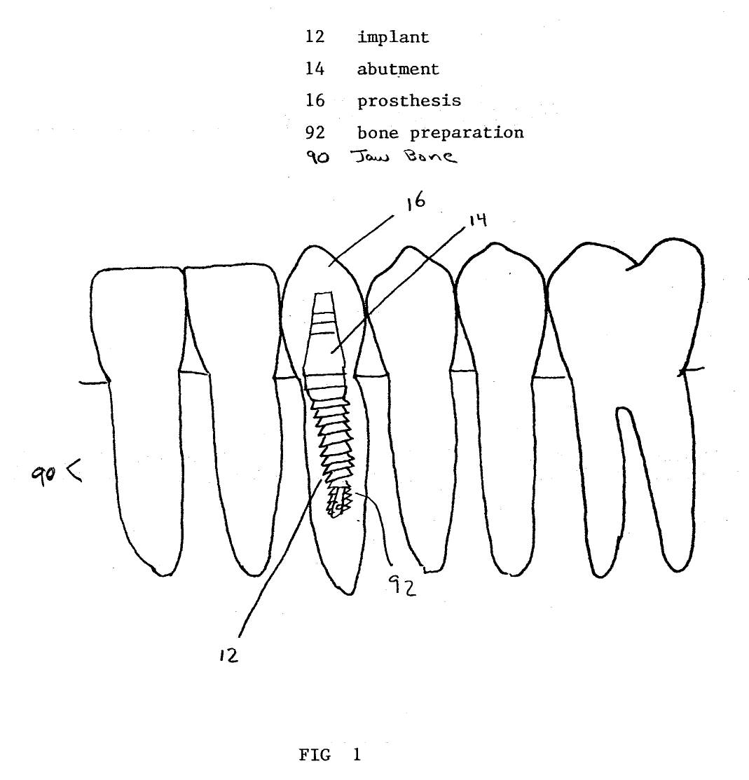

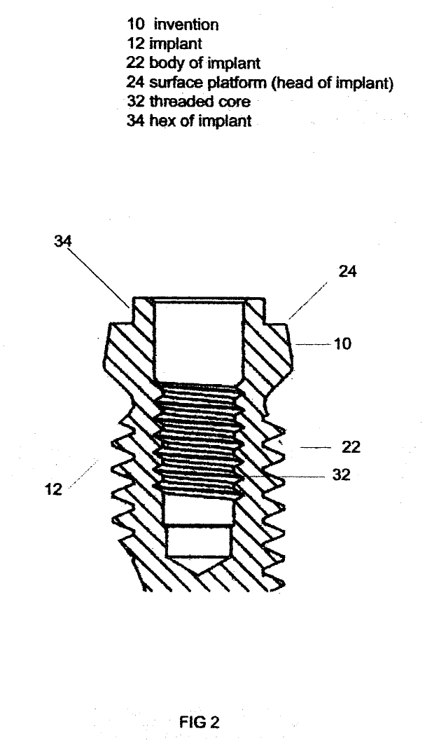

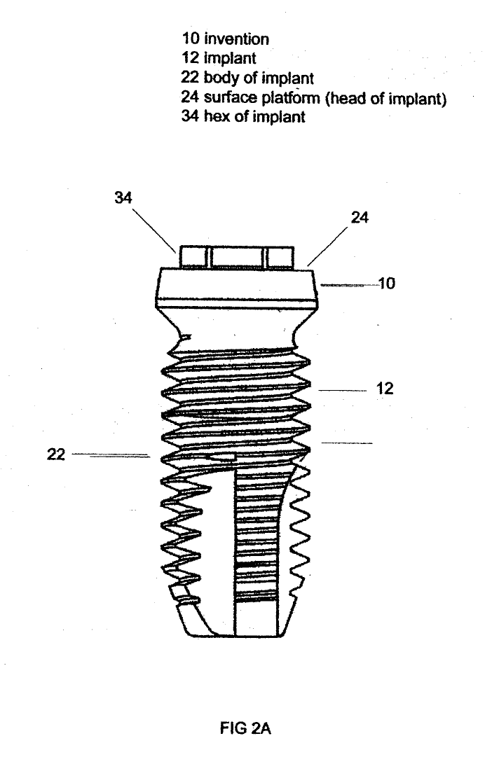

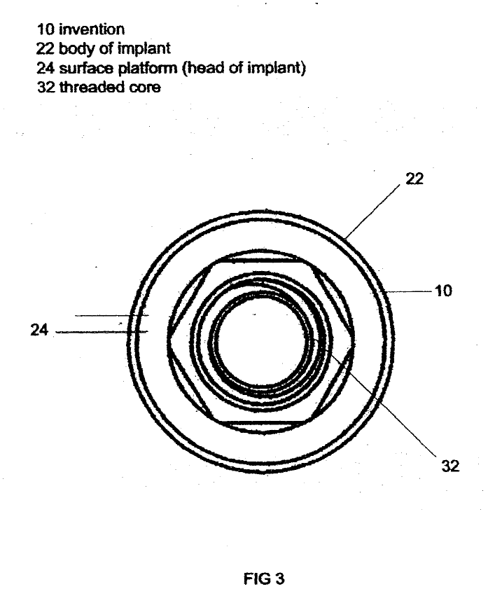

Reference is first made to FIGS. 1-4 in which a dental implant system constructed in accordance with the present invention is generally noted by the character numeral (10), and includes as major components a dental implant (12), an abutment (14) and a prosthesis (16). As shown in FIG. 1, the implant system (10) is mounted in a cavity (92) bored into the jaw bone (90) of the patient such that the implant (12) extends into the jaw bone (90). After the implant (12) is anchored in the jaw bone (90), the abutment (14) is secured to the implant (12) and a prosthesis or artificial tooth (16) can be secured to the abutment (14) as is known in the art. The implant (12), shown in greater detail in FIG. 2, can be formed from any smooth hard material commonly known in the art as being suitable for dental implants; and the body (22) exterior may have a threaded porous or coated surface, as is known in the art. In a preferred embodiment, the implant (12) is machined from titanium, and the body (22) has a threaded exterior surface. As shown in FIGS. 2, 2A, 2B and 3, the head (24) of the implant (12) defines a flat disk with a hexed elevation extending up from it and a neck (10) with a taper consisting of the taper enlarging to the deep aspect of the implant (12), with a fixation screw (30) positioned at essentially the center of the implant (12). The taper angle of the exterior side wall (10) is a Morse taper, i.e. a taper angle of less than about 8 degrees. The fixation screw (30) threads into the implant (12) into a threaded core (32) which has passed through the abutment (14), thereby attaching the abutment (14) to the implant (12). The exterior of the implant (12) includes a hexagonal shaped protuberance (34) that projects up from the surface platform (24) of the implant (12).

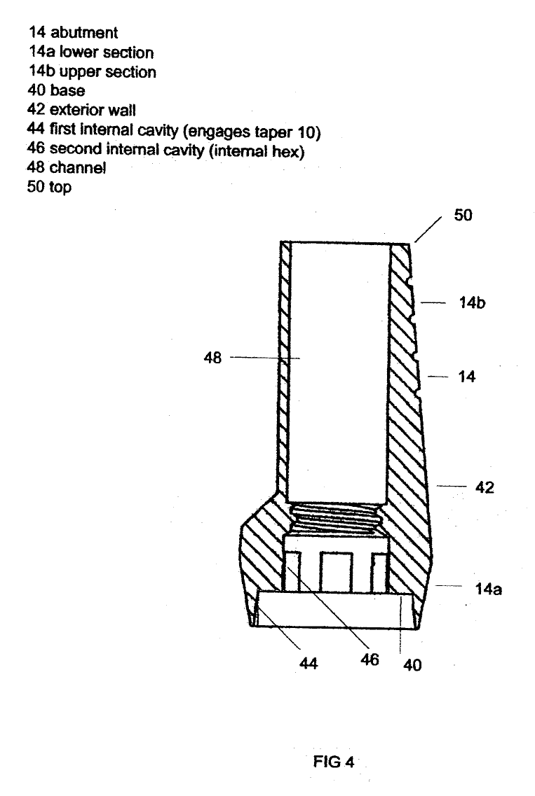

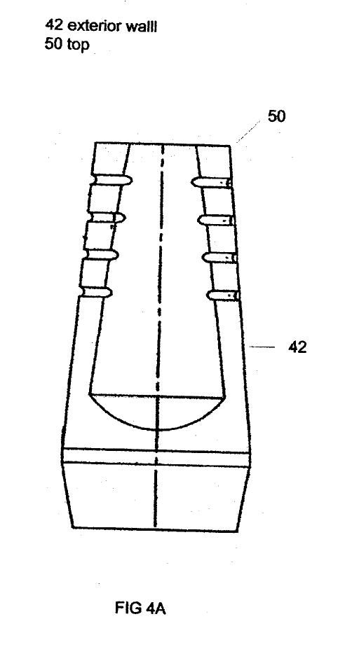

As shown in FIG. 4 and FIG. 4A, the abutment (14) has a base (40) and a top (50) and defines an exterior wall (42), a first internal cavity (44) a second internal cavity (44) and a channel (48). The abutment (14) is divided into two sections, a lower section (14a) and an upper section (14b) which is defined from the internal aspect of the abutment which makes direct contact with the implant head. The lower section of the abutment (14) makes intimate contact internally with its flange (44), its base (40) and its hex (46), to the external surfaces of the implant (12), the tapered neck (10), the surface platform (24) and the external hex (34). The first internal cavity (44) defines an interior wall which presses to the exterior wall (10) of the implant (12). In the embodiment of FIGS. 1-4, the taper angle of the implant wall (10) is preferably a Morse taper, so that the internal abutment wall (44) of the abutment (14) mates with the exterior side wall (10) of the implant (12). The upper section of the abutment (14) defines an exterior wall that can have any angle or geometry that will all the prosthesis (16) to be securely attached. The first internal cavity (44) is a flange in the lower section of (14a) of the abutment and extends circumferentially from the base (40). The second cavity (46) of the abutment has an internal hexagonal shape and is designed to fit over the hexagonal protuberance (34) of the implant (12). In the embodiment of FIGS. 1-4, the first and second internal cavity of the abutment (14) are designed so that when the abutment is positioned on the implant, and is pressed into place by the fixation screw (30), the flange of the abutment (44) will friction lock to the tapered neck (10) of the implant (12) before the base of the abutment (40) contacts the surface platform (24) of the implant (12) while the second internally hexed cavity (46) of the abutment (14) will mate with the externally hexed protuberance (34) of the implant (12). The channel (48) of the abutment permits the fixation screw (30) to be recessed after threading.

The embodiment of the invention includes different geometries of the abutment (14) utilizing various machinations that secure the prosthesis (16) to the abutment (14). It also embodies variations of the externally hexed protuberance (34) of the implant (12) to include any irregular wrench engaging element which will be mated to the second internal cavity (46) of the abutment (14). Thus, the present development for a dental implant system incorporates both a reference for indexing the abutment and tapered walls for reducing the risk of abutment loosening. It is understood that those with skill in the art will be able to make changes and modifications to the invention without departing from the spirit or scope of the invention, as defined herein.

What is claimed is:

1. A dental implant system for securing a prosthesis in a mouth, said system comprising of
a. An implant, defining a head and a body, said body adapted to be secured within a jawbone, and said head defining a neck incorporating a driving and restorative element hexagonal in geometry. Said neck with tapered walls with the greatest size toward the body. Said hexagonal element for indexing and anti-rotational use, which intimately mates to internal hex of said abutment.
b. An abutment having an internal hex less in height than the external hex of the implant and a flange that will engage the taper on the external aspect of the implant
c. A prosthesis which is individually made to be secured to the abutment

2. The dental implant system of claim 1 wherein a flange extends from the base aspect of said abutment.

3. The dental implant system of claim 2 wherein said implant includes an internal threaded channel to receive a screw, and said implant includes a hexed or any irregular wrench engaging external element to act as a driving and indexing component, and said implant to possess a taper on the external wall to interference fit with the flange of said abutment.

4. The dental implant system of claim 1 wherein said indexing means is a hexagonal shaped element or any irregular wrench-engaging element.

5. The dental implant system of claim 4 wherein said abutment cavity defines a hexagonal shape or irregular wrench-engaging element proportioned to engage said implant hexed element or irregular wrench-engaging element.
